(19) United States
(12) Patent Application Publication
(10) Pub. No.: US 2015/0013209 A1
(43) Pub. Date: Jan. 15, 2015

(54) System, Apparatus and Method for Reducing Trawl Bycatch

(71) Applicant: The University of Tasmania, Sandy Bay, Tasmania (AU)

(72) Inventors: Troy Gaston, Wamberal (AU); Rowan Frost, Deviot (AU); Giles Thomas, East Launceston (AU); David Maynard, Deviot (AU)

(21) Appl. No.: 14/379,205

(22) PCT Filed: Feb. 20, 2013
(86) PCT No.: PCT/AU2013/000148

§ 371 Date: Aug. 15, 2014

(30) Foreign Application Priority Data
Feb. 21, 2012 (AU) 2012900652

(51) Int. Cl. A01K 75/02; A01K 74/00; A01K 73/10; A01K 99/00; A01K 79/00

(52) U.S. Cl. CPC A01K 75/02; A01K 99/00; A01K 79/00; A01K 73/10; A01K 74/00
USPC 43/4.5; 43/9.3; 43/17.5

(57) ABSTRACT

A system for reducing trawl bycatch, the system including at least one light arranged externally of the net to stimulate a phototactic response in the major bycatch species present to reduce entry of such species into the net.

### CROSS-REFERENCE TO RELATED APPLICATIONS

This application is a filing under 35 U.S.C. 371 of International Application No. PCT/AU2013/000148 filed Feb. 20, 2013, entitled “System, Apparatus and Method for Reducing Trawl Bycatch,” which claims priority to Australian Patent Application No. 2012900652 filed Feb. 21, 2012, which applications are incorporated by reference herein in their entirety.

### FIELD OF THE INVENTION

The present invention relates to a system, apparatus and method for reducing trawl bycatch.

### BACKGROUND OF THE INVENTION

Previously proposed arrangements to reduce trawl bycatch have focussed on allowing undesired catch (juveniles and non-target species) to escape from trawl nets. For example, bycatch reduction devices (BRDs) have been proposed to allow undesired catch to escape from codends of trawl nets. A significant problem with this is that of loss from the required catch. Another problem is that an unknown, but potentially significant, proportion of escaping catch die (termed “post-escape mortality”).

What is needed is a solution for reducing trawl bycatch that addresses the above difficulties.

### SUMMARY OF THE INVENTION

According to the present invention, there is provided a system for reducing trawl bycatch, the system including at least one light adapted to be arranged externally of the net to stimulate a phototactic response in the major bycatch species present to reduce entry of such species into the net.

The light may illuminate downwardly to exploit negative phototaxis, upwardly to exploit positive phototaxis, or at a range of intermediate orientations. In practice, the orientation of the light can be selected by the user depending on the major bycatch species likely to be present at any particular location, season or time.

According to the present invention, there is also provided a system for increasing trawl catch, the system including at least one light arranged externally of the net to stimulate a phototactic response in the major species present to attract such species toward the net.

The light may illuminates downwardly to exploit positive phototaxis. The light may also illuminate at an angle inclined to the vertical.

Alternatively or in addition to varying the orientation of the illumination, the wavelength and/or intensity of the illumination can be varied and/or a strobe effect can be provided.

For prawn (or shrimp) trawling the light is arranged in advance of or at a mouth of the trawl net whereas for fish trawling the light may be arranged towards the rear of the net.

There is also disclosed an underwater light apparatus for use in the systems defined above, the apparatus including a waterproof housing, a towing attachment arranged on the housing, a generator inside the housing, a turbine for driving the generator, when the apparatus is forced through the water with the net, and a light source connected to the generator and arranged in the housing to illuminate through a light transmissive portion of the housing.

In one embodiment, the turbine which is arranged externally of the waterproof housing, is at the forward end thereof, the orientation of the light transmissive portion determining the orientation of the illumination.

The present invention also provides an underwater light apparatus for use in the system defined above, including a waterproof housing, coupling means for coupling the apparatus proximal to the net, and at least one light source, the apparatus being configured to selectively illuminate in different orientations comprising a downwards direction, a forwards direction and an upwards direction.

The coupling means can be arranged on the housing and adapted for coupling to the headline.

The at least one light source can include an upward facing light source, a forward facing light source and a downward facing light source, each being selectively operable.

The present invention also provides a method for reducing trawl bycatch, the method including the step of providing illumination externally of a trawl net during towing thereof so as to stimulate a phototaxis response in at least some undesired species which causes at least some of them to avoid entering the trawl net.

The present invention further provides a method of increasing trawl catch, the method including the step of providing illumination externally of a trawl net during towing thereof so as to stimulate a phototaxis response in at least some species which causes at least some of them to be attracted toward the trawl net.

### BRIEF DESCRIPTION OF THE DRAWINGS

An embodiment of the invention will be described by way of example only with reference to the accompanying drawings, in which:

FIG. 1 is a perspective view of an embodiment of a trawl bycatch reduction system of the invention;

FIG. 2 is a top plan view of the system;

FIG. 3 is an embodiment of an underwater light apparatus used in the system;

FIG. 4 is a perspective view of a further embodiment of an underwater light apparatus used in the system;

FIG. 5 is a top plan view of the underwater light apparatus of FIG. 4;

FIG. 6 is a side view of the underwater light apparatus of FIG. 4;

FIG. 7 is rear view of the underwater light apparatus of FIG. 4;

FIG. 8 is a front view of the underwater light apparatus of FIG. 4;

FIG. 9 is an exploded perspective view of the underwater light apparatus of FIG. 4;

FIG. 10 is a schematic wiring diagram of the underwater light apparatus of FIG. 4; and

FIG. 11 is a perspective view of a further embodiment of a trawl bycatch reduction system.

### DETAILED DESCRIPTION OF THE INVENTION

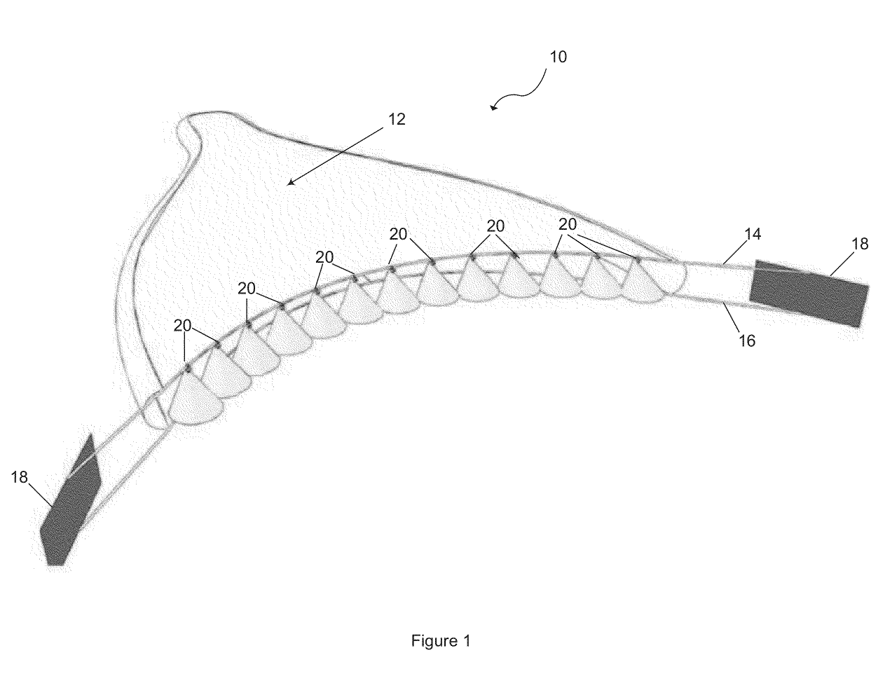

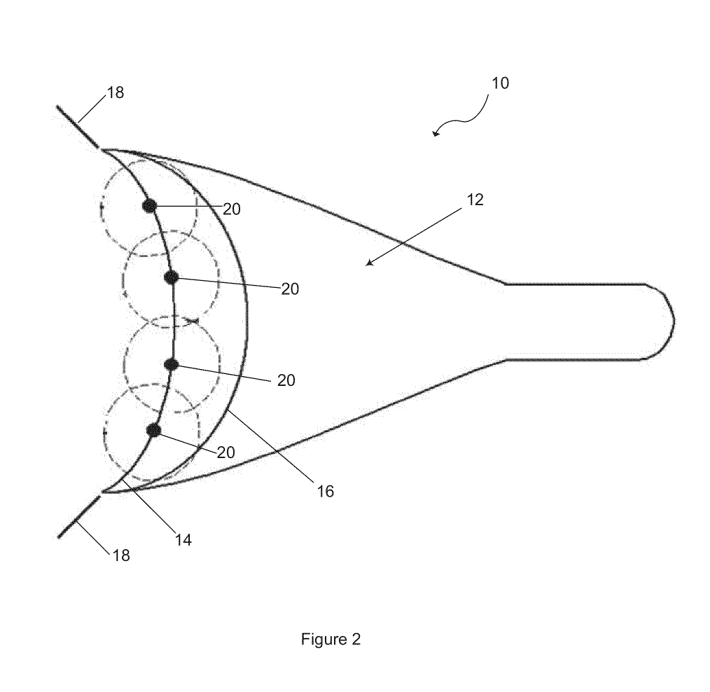

FIGS. 1 and 2 illustrate an embodiment of a system 10 for reducing trawl bycatch. The system 10 is attached to a conventional trawl net 12 having a mouth defined by a headline 14 and a footrope 16 vertically spaced apart by trawl doors (or otter boards) 18. The system 10 includes a plurality of lights 20 arranged generally equidistant from one another along the headline 14 to illuminate downwardly across and over the mouth of the trawl net 12.

During towing of the trawl net 12 by a trawler (not shown), the lights 20 are activated so as to produce a plurality of downwardly diverging illumination cones having at least partially overlapping illumination footprints on the seabed or in the water column underlying the mouth of the trawl net 12.

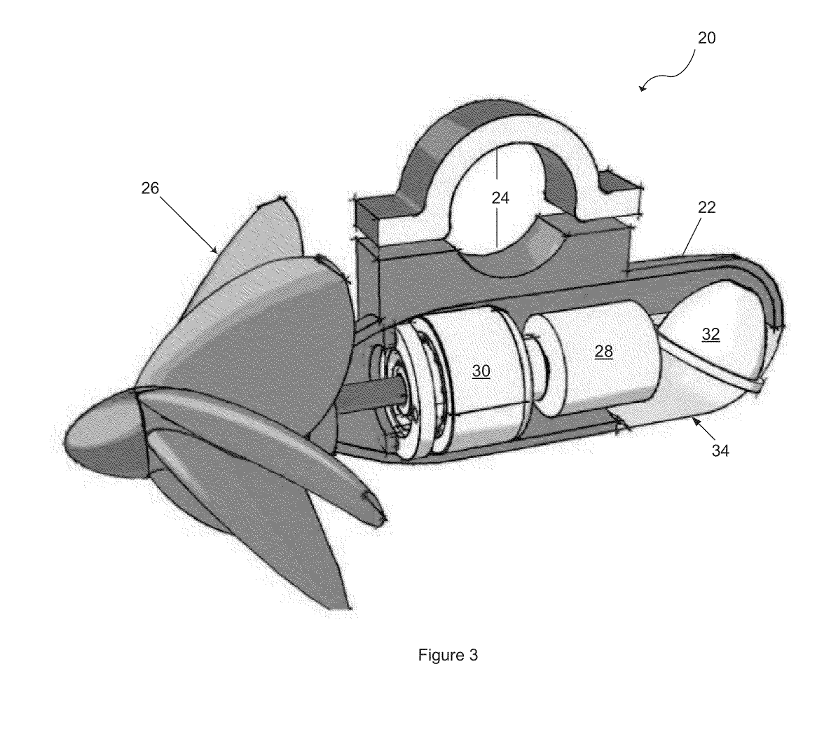

FIG. 3 illustrates one embodiment of an underwater light apparatus 20 used in the system 10. The apparatus 20 includes an elongate waterproof housing 22 having forward and rearward ends. An upper towing attachment 24 is arranged on the housing 22 between the forward and rearward ends to removably connect the apparatus 20 to the headline 14 of the trawl net 12. A turbine 26 is arranged forwardly of the housing 22. A generator 28 inside the housing 22 is connected to the turbine 26 by a coupling 30. The generator 28 powers a light source 32 arranged in the rearward end of the housing 22 to illuminate downwardly and forwardly through a lower light transmissive portion 34 of the housing 22.

The housing 22 is, for example, formed as an injection moulding in high density polycarbonate. The upper towing attachment 24 is, for example, a twin bolt double saddle which allows the apparatus 20 to be easily and quickly installed on the headline 14 of the trawl net 12. The turbine 26 is, for example, an open blade axial-flow horizontal turbine made of high density rubber with a low aspect ratio and a high thickness and rake so as to shed debris encountered during towing. The coupling 30 is, for example, a magnetic coupling that is pressure rated to a water depth of 300 metres. The light source 32 is, for example, a 3 Watt, 98° beam angle LED light emitting diode (LED) which uses heat sink into the surrounding water to achieve a burn time in excess of 30000 hours. The light transmissive portion 34 is, for example, an optical quality light lens that is integrally formed in the polycarbonate housing 22. Other equivalent components and materials may also be used in the underwater light apparatus 20.

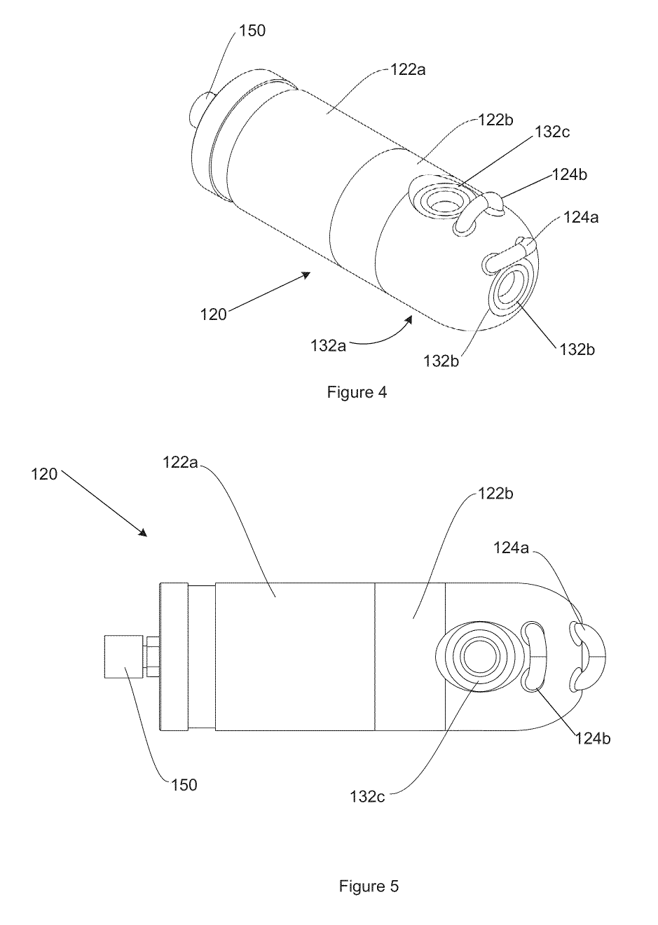

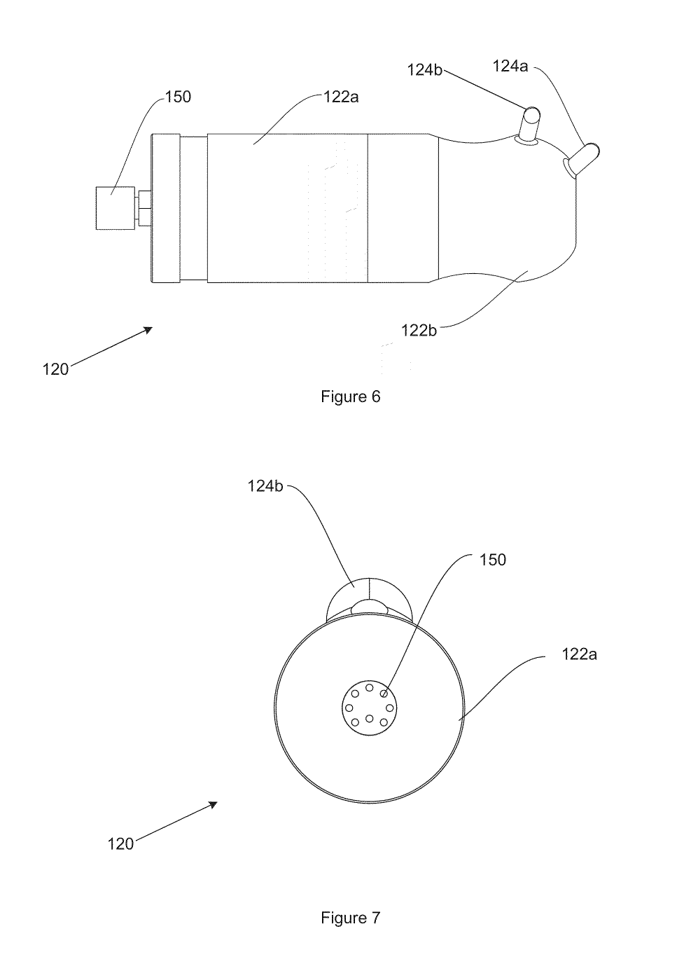

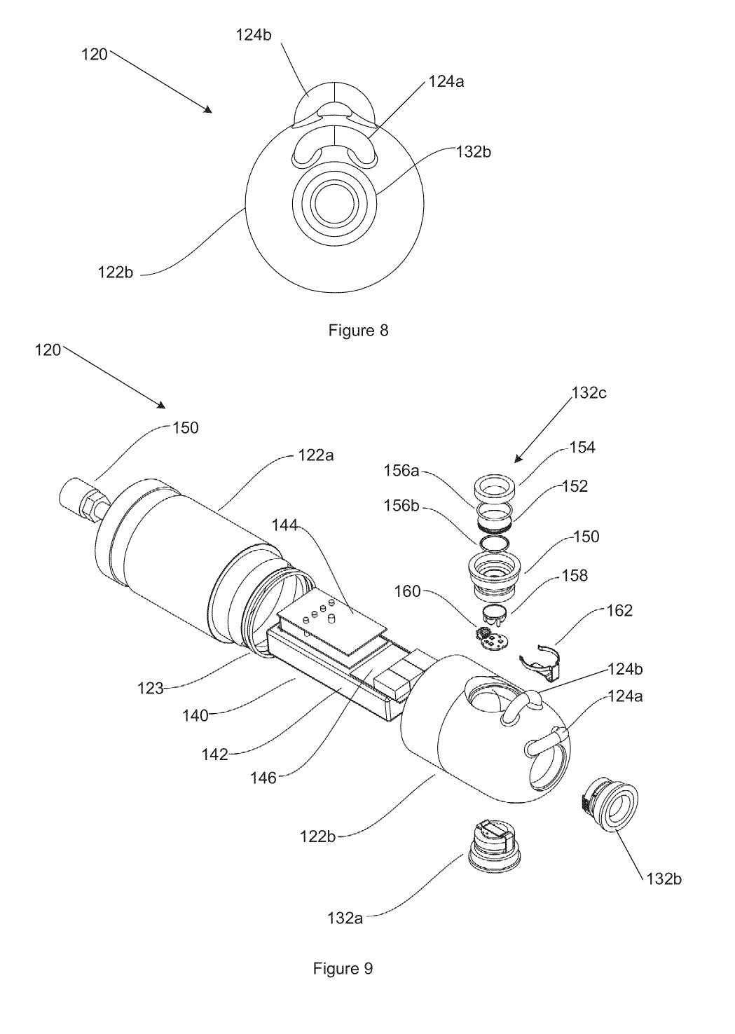

FIG. 4 illustrates another embodiment of an underwater light apparatus 120 for use in the system 10. The apparatus 120 includes a housing in the form of a front casing 122a and a rear casing 122b, between which a pair of o-ring seals 123 are disposed to seal the apparatus 120. The apparatus 120 includes at least one light source and is configured to selectively illuminate in different orientations comprising a downwards directions, a forwards direction and an upwards directions. In the illustrated embodiment the apparatus 120 includes three light sources in the form of LED assemblies, a downward facing LED 132a, a forward facing LED 132b, and an upward facing LED 132c. It will be appreciated that a single light source may be provided within the housing and configured to be pivotable so as to vary the orientation of illumination as required. Furthermore, although the LED's are shown to be either vertical or horizontal, they may be otherwise inclined, such as at intermediate angles in between those shown.

The LED's 132a, 132b, 132c can be selectively operated, individually or in combination, as required. The apparatus 120 is electrically coupled to the system 10 via connector 150 and physically coupled proximal to a mouth of the trawl net via a coupling means, which in the described embodiment is a pair of rigid mounting points 124a, 124b which are arranged on the housing and fixed to the front casing 122a.

As illustrated in FIG. 9, the front casing 122a can be separated from the rear casing 122b so as to provide access to internal components of the apparatus 120. Within the apparatus 120 is an electronic module 140 that includes a battery 142, battery charger 144 and a LED driver 146. The LED's are powered by the battery 142, which may be charged in situ or removable for charging. In other embodiments, the LED's may be powered via a power cable extending from the system 10 and connected to the connector 150.

In FIG. 9, the upward facing LED 132c is shown in an exploded configuration. The LED 132c includes a housing 150, a lens 152 and a lens retaining ring 154. Disposed on either side of the lens 152 are sealing o-rings 156a, 156b. The LED 132c also includes an optical element 158 and a PCB 160, each of which are fixed to the LED 132c by a retaining clip 162. Each LED of the apparatus 120 is, for example, a 7 Watt 35° beam angle LED, though it will be appreciate that LED's of other configurations could similarly be used.

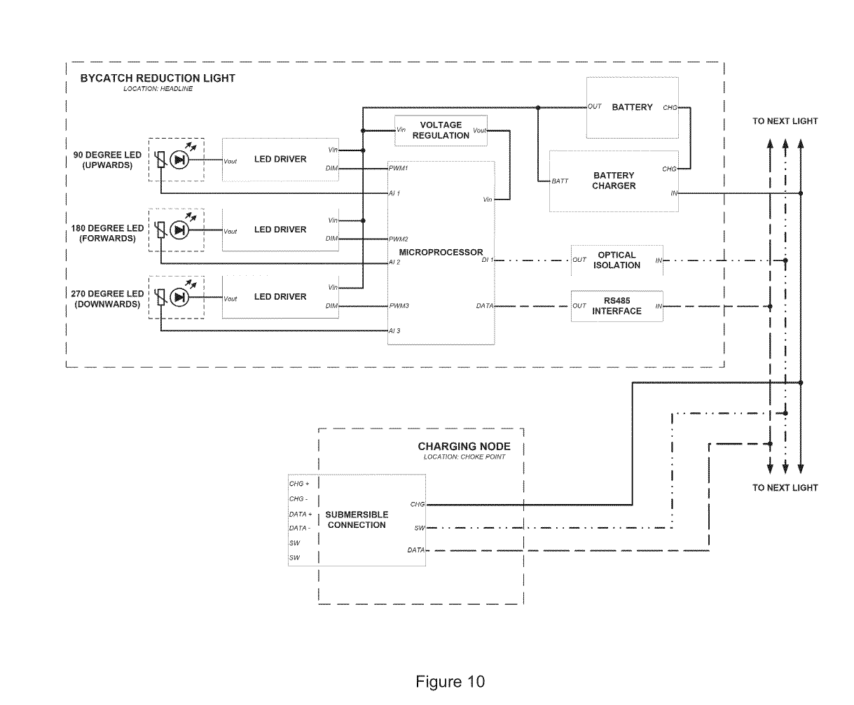

FIG. 10 illustrates a schematic diagram of the apparatus 120, illustrating how a plurality of apparatuses 120 can be electrically coupled to each other within the system 110. A data link is provided so as to allow communication between a controller (not shown) and the apparatuses 120 so that the LED's can be selectively operated.

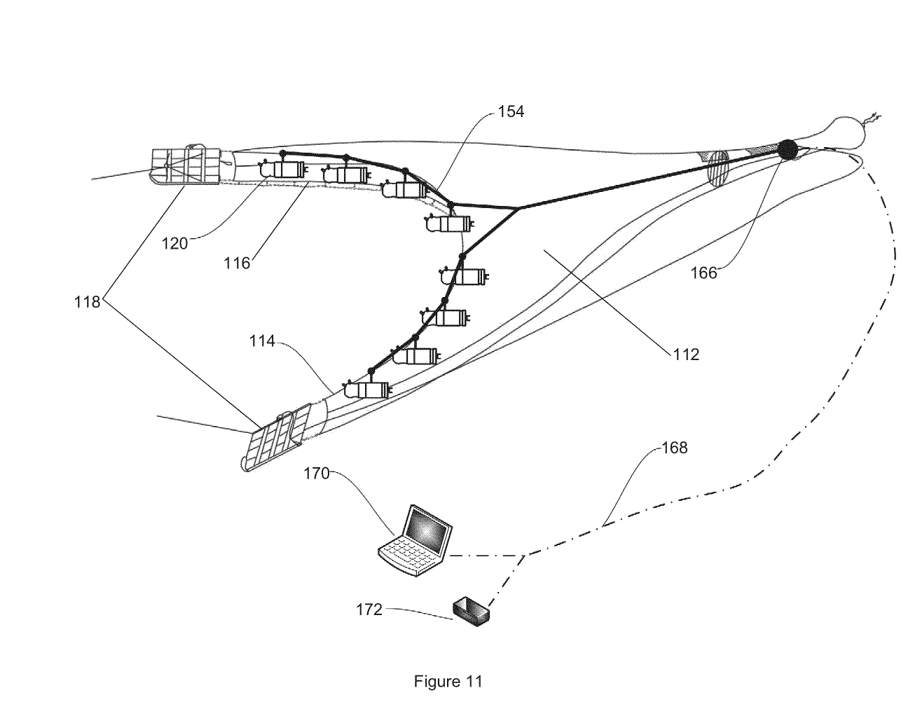

FIG. 11 illustrates a further embodiment of a trawl bycatch reduction system 110, incorporating a plurality of underwater light apparatuses 120. It will be appreciated that system 110 could include a plurality of underwater light apparatuses 10 as previously described, and that system 10 could similarly incorporate a plurality of underwater light apparatuses 120.

The trawl bycatch reduction system 110 includes a conventional trawl net 112 having a mouth defined by a headline 114 and a footrope 116 vertically spaced apart by trawl doors (or otter boards) 118. The system 110 includes a plurality of lights 120 arranged generally equidistant from one another along the headline 114 to illuminate downwardly across and over the mouth of the trawl net 112. The lights 120 are electrically coupled, via a cable 164, to each other and a charging node 166. The charging node is connected via a cable 168 to a controller 170, which in the illustrated embodiment is a computer, and a power source 172.

In use, the system 10, 110 provides illumination generally directly downwards in advance or at the mouth of the trawl net 12, 112 which stimulates negative phototaxis (a flight response with movement away from light) in at least some undesired species which causes at least some of them to avoid entering the trawl net 12, 112 thereby at least partially reducing trawl bycatch. The system 10, 110 obviates the problem of catch loss and post-escape mortality by deterring undesired species from entering the trawl net.

Although the system described above provides illumination generally downwards, as previously explained the illumination could alternatively be generally upwards for positively phototactic species or at an intermediate orientation. Illumination generally upwards and away from the mouth of the net can act to draw fish which exhibit a positive phototactic response away from the mouth of the net. In this regard, if an unwanted species which is known to exhibit a positive phototactic response, such as pony fish, is present in the area, providing illumination which is generally upwards and away from the mouth of the net can reduce the catch of that species because it is drawn away from the mouth of the net. The orientation of the illumination from apparatus 20 can be varied by varying the position of the light transmissive portion 34 in the housing 22. The orientation of illumination from apparatus 120 can be varied by selectively operating the desired LED 132a, 132b or 132c.

Embodiments of the invention can be used in all types of trawling, but are particularly advantageous in prawn (or shrimp) trawling which is known to have the highest rate of bycatch. For example, it is estimated 7.3 million tonnes of fish are discarded as bycatch each year. Tropical shrimp trawling is estimated to be responsible for a quarter of this annual bycatch. For every kilogram of marketable prawns, there are between 3 and 20 kilograms of undesired fish discarded at sea as bycatch.

It has been surprisingly found that when embodiments of the invention are attached to prawn trawl nets, fish bycatch is reduced by up to 30 percent, and prawn catch is increased by up to 30 percent. Based on these results, embodiments of the invention have the potential to reduce significantly global bycatch, thereby significantly improving the sustainability of non-target species, as well as the sustainability of juvenile commercial species that cohabit with prawns.

It will be appreciated that different species of marine life will exhibit a different phototactic response, and that this response may vary according to the prevailing conditions at the trawl site and throughout the lunar cycle. Accordingly, the configuration of the system 10, 110 may be varied as required, having regard to the target catch and the species of unwanted catch present in the trawl area at that time. In this regard, parameters of the illumination, such as wavelength, brightness and beam orientation may be varied to suit the prevailing conditions. Also, the illumination may be in the form of a strobe or flashing light.

The decrease in bycatch means trawlers will have reduced fuel costs as they are trawling with less drag from their trawl nets. The surprising and unexpected increase in prawn catch that accompanies the decreased bycatch means that prawn fishermen can reduce their number of fishing days to catch a given quota of prawns. Moreover the reduction in bycatch means that net shape is not compromised and subsequent processing time, and hence labour costs, is reduced.

This proposed system for reducing bycatch may also be used in conjunction with other systems for reducing bycatch.

It will be appreciated that the described system 10, 110 may also be used to increase trawl catch of species which exhibit a positive phototactic response. In this regard, the illumination can act to attract that species toward the net to increase the catch.

The embodiments have been described by way of example only and modifications are possible within the scope of the invention disclosed.

1. A system for reducing trawl bycatch, the system including at least one light arranged externally of the net to stimulate a phototactic response in the major bycatch species present to reduce entry of such species into the net.

2. The system according to claim 1, wherein the light illuminates downwardly to exploit negative phototaxis.

3. The system according to claim 1, wherein the light illuminates upwardly to exploit positive phototaxis.

4. The system according to claim 1, wherein the light illuminates at an angle inclined to the vertical.

5. The system according to claim 1, wherein the mouth of the trawl net is upwardly defined by a headline, and wherein the at least one light is adapted to be arranged on the headline.

6. A system for increasing trawl catch, the system including at least one light arranged externally of the net to stimulate a phototactic response in the major species present to attract such species toward the net.

7. The system according to claim 6, wherein the light illuminates downwardly to exploit positive phototaxis.

8. The system according to claim 6, wherein the light illuminates at an angle inclined to the vertical.

9. The system according to claim 6, wherein the mouth of the trawl net is upwardly defined by a headline, and wherein the at least one light is adapted to be arranged on the headline.

10. The system according to claim 1, having a plurality of lights arranged generally equidistant from one another along the headline to illuminate downwardly across and over the mouth of the trawl net.

11. The system according to claim 10, where the plurality of lights respectively illuminate downwardly to produce a plurality of downwardly diverging illumination cones having at least partially overlapping illumination footprints on the seabed or in the water column underlying the mouth of the trawl net.

12. The system according to claim 1, wherein the light has a variable intensity and/or wavelength.

13. The system according to claim 1, wherein the light produces a strobe effect.

14. The system according to claim 1, wherein the or each light includes at least one light emitting diode (LED).

15. An underwater light apparatus for use in the system according to claim 1, including a waterproof housing, coupling means for coupling the apparatus proximal to the net, and at least one light source, the apparatus being configured to selectively illuminate in different orientations comprising a downwards direction, a forwards direction and an upwards direction.

16. The underwater light apparatus as claimed in claim 15, wherein the coupling means is arranged on the housing and adapted for coupling to the headline.

17. The underwater light apparatus as claimed in claim 15, wherein the at least one light source includes an upward facing light source, a forward facing light source and a downward facing light source, each being selectively operable.

18. A method for reducing trawl bycatch, the method including the step of providing illumination externally of a trawl net during towing thereof so as to stimulate a phototaxis response in at least some undesired species which causes at least some of them to avoid entering the trawl net.

19. A method of increasing trawl catch, the method including the step of providing illumination externally of a trawl net during towing thereof so as to stimulate a phototaxis response in at least some species which causes at least some of them to be attracted toward the trawl net.
